(19) United States
(12) Patent Application Publication
(10) Pub. No.: US 2018/0050449 A1
(43) Pub. Date: Feb. 22, 2018

(54) MOBILITY SYSTEM

(71) Applicant: FORD GLOBAL TECHNOLOGIES, LLC, Dearborn, MI (US)

(72) Inventors: Frederic STEFAN, Aachen NRW (DE); Uwe GUSSEN, Huertgenwald NRW (DE); Frank PETRI, Erftstadt (DE)

(73) Assignee: FORD GLOBAL TECHNOLOGIES, LLC, Dearborn, MI (US)

(21) Appl. No.: 15/679,883

(22) Filed: Aug. 17, 2017

(30) Foreign Application Priority Data
Aug. 17, 2016 (DE) 102016215399.4

(51) Int. Cl. B25J 9/00; A61H 3/00; A61G 5/14

(52) U.S. Cl. CPC B25J 9/0006; A61H 3/00; A61G 5/14; A61H 2201/0157; A61H 2201/50; A61H 2201/0119; A61H 2003/007

(57) ABSTRACT

The disclosure relates to a mobility system. The mobility system has at least one driven exoskeleton for a person. The at least one driven exoskeleton has at least one electronic unit that controls and/or regulates an operating state of the exoskeleton. At least one vehicle has a passenger compartment and at least one mechanical coupling station, which is arranged in the passenger compartment. The exoskeleton can be mechanically coupled to the mechanical coupling station. The vehicle has at least one electronic device, wherein the electronic unit is connectable, via at least one communication connection, to the electronic device.

### CROSS-REFERENCE TO RELATED APPLICATIONS

This application claims foreign priority benefits under 35 U.S.C. § 119(a)-(d) to DE Application 10 2016 215 399.4 filed Aug. 17, 2016, which is hereby incorporated by reference in its entirety.

### TECHNICAL FIELD

The disclosure relates to a mobility system having at least one electronic control unit to regulate an operating state of an exoskeleton.

### BACKGROUND

The mobility of people is subjected to new demands with the increase of the world population, and the breakthrough of mobility solutions that are linked to one another and automated. More and more people have to travel farther, and as efficiently as possible. A so-called multimodal journey requires of a person that, before reaching their respective destination, they change the transportation means once or multiple times (for example, car+train+bus). In many situations, these changes are linked to a time loss and/or time delays. In other cases, it can occur that the destination is not directly reachable by conventional transportation. This can occur, for example, if a destination is in a pedestrian zone, or in a zone having intensive traffic (city center) and poor parking options. Such a situation can be extremely burdensome in particular for people who have to carry a heavy load, for physically handicapped people, for people having reduced mobility, for older people, or for people who have longer travel routes.

Many concepts exist that offer solutions for the last section of a journey, for example, scooters, electric scooters, collapsible bicycles, electric bicycles, Segway® Personal Transporters, and the like. However, many of these solutions are bulky, do not offer good weather protection, and are not suitable for rough ground (for example, non-asphalted roads) or for transporting heavy or bulky loads. Vehicle sharing, for example, car sharing, bicycle sharing, and the like, does represent a good solution, but this service offers a limited number of vehicles per geographical region, whereby the service is not always reliably ensured. Finally, some of these services are still linked to so-called stations, which are not available everywhere.

### SUMMARY

One object of the disclosure is to improve the mobility of people.

A mobility system according to the disclosure comprises at least one driven exoskeleton for a person, which has at least one electronic unit configured to control and/or regulate an operating state of the exoskeleton, and at least one vehicle having a passenger compartment and at least one mechanical coupling station, which is arranged in the passenger compartment that the exoskeleton can be mechanically coupled, wherein the vehicle has at least one electronic device, and the electronic unit is connectable via at least one communication connection to the electronic device.

According to the disclosure, the driven exoskeleton can be integrated into the vehicle. In this way, for example, the last section of a journey and/or any type of an intelligent modal mobility solution can be assisted. The disclosure enables in particular an operating mode that allows multimodal coupling and decoupling of exoskeletons, according to the disclosure, to coupling stations of vehicles, wherein the exoskeletons are used as mobility devices by end users. The exoskeleton coupled to the coupling station can change form such that it assists the person using the exoskeleton in any desired posture, for example, a seated posture or a standing posture.

A unidirectional or bidirectional data exchange between the exoskeleton and the vehicle can occur via the communication connection between the electronic unit of the exoskeleton and the electronic device of the vehicle. The communication connection can be wireless or wired. Different data can be exchanged between the exoskeleton and the vehicle via the communication connection, as described by way of example hereafter. The communication connection can be automatically established when the person using the exoskeleton approaches the vehicle, enters the passenger compartment, or is located in the passenger compartment. In particular, the communication connection can be established after the exoskeleton has been coupled to the coupling station. Alternatively, the communication connection can be established when this is requested by the person by actuating an operating element.

The mobility system according to the disclosure or the at least one exoskeleton thereof, respectively, can comprise four special operating modes, namely one operating mode for entering the vehicle (coupling mode), one operating mode for leaving the vehicle (decoupling mode), one operating mode for walking (walking mode), in which the person using the exoskeleton moves around solely via the exoskeleton, and one operating mode for traveling (travel mode), in which the person using the exoskeleton moves around via another type of transportation, for example, a passenger automobile, public transit (for example, bus, subway, train, streetcar, aircraft, ship), or a utility vehicle.

The coupling mode and the decoupling mode may be characterized by a series of operating sequences, which have the goal of coupling the exoskeleton to the coupling station of the vehicle or decoupling it from the decoupling station, respectively, via mechanical, electrical, and electronic interfaces. A mechanical interface is used in this case to mechanically couple the exoskeleton to the coupling station. An electrical interface is used to unidirectionally or bidirectionally exchange electrical energy between the exoskeleton and the vehicle. The electrical interface may be arranged partially on the coupling station or separately from the coupling station. An electronic interface is understood as a communication interface, through which a unidirectional or bidirectional data exchange is possible between the electronic unit of the exoskeleton and electronics of the vehicle. The electronic interface may be arranged partially on the coupling station or separately from the coupling station. Alternatively, a wireless data exchange can occur between the electronic unit of the exoskeleton and the electronics of the vehicle.

The driven exoskeleton can offer a large selection of functions and advantages. For example, the driven exoskeleton can be configured for improving a walking speed, walking assistance, guiding the person via the electronic unit, which is, for example, an onboard computer, heating of at least one section of the exoskeleton, protection against bad weather, at least partial assistance when carrying heavy objects, individual assistance of physically handicapped people, individual assistance of older people, physical protection, and/or movement on any type of underlying surface, for example, on steps, asphalt, mud, and the like. The electronic unit of the driven exoskeleton may be supplied, by vehicle electronics, or via another type of communication network, with data, such as, for example, an accurate cartography of the surroundings and/or a route to the respective destination, with entertainment data, or the like.

The exoskeleton according to the disclosure may be used in particular as a mobility device for the last section of a journey, which can be completely mechanically, electrically, and/or electronically integrated into vehicles according to the disclosure, and is equipped with certain operating modes, to be able to be coupled to a coupling station or decoupled therefrom in a simple and reliable manner in a vehicle according to the disclosure. Such robot-like exoskeletons offer many advantages with respect to assisting people having restricted mobility, increasing a storage capacity of a vehicle, a walking speed increase, and the like. In addition, the exoskeleton according to the disclosure can have weather protection and can ensure safer mobility on various types of rough underlying surfaces.

The mechanical, electrical, and electronic integration proposals and the above-mentioned operating modes (coupling mode, decoupling mode, walking mode, travel mode) of the mobility system are described further hereafter.

The exoskeleton according to the disclosure can be coupled to a vehicle seat that has or forms a coupling station. For this purpose, a seat part and/or a back part of the vehicle seat alone has at least one dimensionally-stable shell, which forms a receptacle, into which at least one section of the exoskeleton is at least partially inserted. In this case, the exoskeleton can be folded or collapsed to a certain extent. Alternatively, the exoskeleton can be coupled to a coupling station and can itself form a complete vehicle seat, or can completely replace a conventional vehicle seat. By way of this exoskeleton integration into the vehicle, according to the disclosure, any type of vehicle seat can be partially or completely replaced.

In any case, the person using the exoskeleton, for example, the driver, can be harnessed on the exoskeleton before she leaves the vehicle. During the travel mode, the exoskeleton is securely fixed to the vehicle via the coupling station. The exoskeleton can preferably only be disengaged from the vehicle or the coupling station when the vehicle is at a standstill, and the person using the exoskeleton has activated a certain operating mode. When the person has left the vehicle, the travel mode is not available.

When the person using the exoskeleton is seated in the vehicle, they can be seated, for example, on a section of the collapsed exoskeleton, which provides a seat surface. A typically provided safety belt can be replaced by fixing belts to the exoskeleton such that a person may be harnessed on the exoskeleton. The exoskeleton fixing belt may be a part of the seat surface, and extended therefrom out of the seat surface section of the exoskeleton to buckle in, or harness, the person, wherein the exoskeleton includes at least one retrieval unit that retracts an unused fixing belt.

An exemplary embodiment of the coupling mode will be described hereafter. When a person enters a vehicle, the following sub-modes of the coupling mode can be activated, wherein each sub-mode is preferably only activated when the preceding sub-mode is ended. A sitting-down sub-mode, for example, assisting the person using the exoskeleton when sitting down. Alternatively or additionally, a standing-up sub-mode assists the person using the exoskeleton when standing up. A fixing sub-mode ensures the mechanical, electrical, and/or electronic connection between the coupling station and the exoskeleton coupled to the coupling station. An unharnessing sub-mode enables the person using the exoskeleton to unharness themselves from the exoskeleton, if possible, and if necessary.

An exemplary embodiment of the decoupling mode will be described hereafter. When a person using the exoskeleton wishes to leave the vehicle with the exoskeleton (it is also possible to leave the vehicle without the exoskeleton), they can activate a harnessing sub-mode, in which the person is harnessed to the exoskeleton. The harnessing sub-mode may preferably only be activated when the energy level of an electrical energy store, or battery, of the exoskeleton is above a limiting value. During the harnessing sub-mode, the person should remain seated and bind themselves via special fixing belts to the exoskeleton, wherein the fixing belts can be extended for this purpose by the person from a section of the exoskeleton, which provides a seat surface. In this way, a back part of the exoskeleton and thigh parts of the exoskeleton can be fastened on the person. As soon as this has been performed, a disengagement sub-mode can be activated, to disengage the exoskeleton from the mechanical, electrical, and/or electronic interface or the coupling station. As soon as this has been performed, the person can activate a disembarking sub-mode and leave the vehicle. In the disembarking sub-mode, the person can stand up with assistance by the exoskeleton and leave the vehicle. For this purpose, for example, lower leg sections and foot sections of the exoskeleton can be used. The person can place their feet in, or on, the foot sections, and can subsequently continue the journey via the exoskeleton.

An exemplary embodiment of the travel mode will be described hereafter. Firstly, an example will be discussed, in which the person using the exoskeleton is a driver of an automobile. When the person returns to the automobile, the coupling mode is automatically, or manually initiated. Firstly, the sitting-down sub-mode can be activated by the person, wherein the person disengages their feet from the feet part of the exoskeleton, and the lower leg parts of the exoskeleton are folded down. When this has been performed, the person can lean back, and the fixing sub-mode is activated to securely connect the exoskeleton to the coupling station. When this has been performed, the unharnessing sub-mode can be activated, in which the person can disengage the fixing belts. Subsequently, the vehicle can be driven normally.

Next, an example of a travel mode in public transit will be discussed. In this example, the exoskeleton can be integrated into any type of public transit, for example, a bus, a subway, an aircraft, or the like. The public transit preferably comprises in its passenger interior multiple standardized coupling stations according to the disclosure, to each of which at least one exoskeleton according to the disclosure can be mechanically, electrically, and/or electronically coupled. The functionalities linked to the mechanical, electrical, and/or electronic integration are similar to the functionalities that are provided in a passenger automobile and described above. The exoskeleton is typically in the walking mode when the person using the exoskeleton enters the public transit. A standing sub-mode of the coupling mode can be activated by the person and/or automatically by the public transit via a certain communication system. The person can then couple the exoskeleton to a free coupling station in the public transit. The public transit can guide the person via signaling to the closest available coupling station. The fixing sub-mode of the coupling mode is activated as soon as the exoskeleton is coupled to the coupling station. The coupling station can exchange energy and items of information, for example an entertainment offering, a connectivity, a usage capability, or the like, with the exoskeleton. The coupling can be performed such that the exoskeleton assists a standing posture or a seated posture of the person depending on the personal wish and/or depending on the respective travel duration. For safety reasons, it can be provided that the unharnessing sub-mode is not activatable by the person during the travel using the public transit. When the person using the exoskeleton wishes to leave the public transit, the person will decouple the exoskeleton from the coupling station and activate the walking mode. The walking mode is the operating mode of the exoskeleton in which solely the exoskeleton is used as a mobility device. The walking mode can be activated as soon as the decoupling mode has been completed.

The electronic (digital) integration of the exoskeleton into the vehicle will be described hereafter. Multiple digital interactions can be offered via an interface between the vehicle and the exoskeleton. For example, an intelligent seat function can be offered, in which a seat position adjustment can be carried out via actuators of the exoskeleton, which enables a higher degree of freedom. Alternatively or additionally, seat comfort properties, for example a massage function or a back support function, can be activated by actuators of the exoskeleton. Alternatively or additionally, heating or cooling of a section of the exoskeleton in contact with the person can be carried out via a heating device or cooling device, respectively, of the exoskeleton.

Furthermore, for example, intelligent energy management can be implemented. In this case, the exoskeleton can be supplied with electrical energy by the vehicle during the travel mode, whereby, for example, an electrical energy store of the exoskeleton can be charged. Alternatively or additionally, the exoskeleton can be used as an additional electrical storage capacity for electrical energy reclamation (recuperation) during the travel of the vehicle. In this way, it is also possible to reduce in size electrical storage units of the vehicle, depending on how many exoskeletons are integrated into the vehicle. Alternatively or additionally, the exoskeleton may be used to supply the onboard electrical system of the vehicle with electrical energy if the energy level of an electrical storage unit of the vehicle is below a limiting value, and if the energy level of the electrical store of the exoskeleton is above a limiting value.

Furthermore, for example, an intelligent data exchange can be offered. For example, the vehicle can transmit navigation data or a computed route to the exoskeleton, to enable a seamless continuation of the journey using the exoskeleton after leaving the vehicle. Alternatively or additionally, the vehicle can transmit any type of computing-intensive items of information as preprocessed items of information to the exoskeleton, to save capacities of the electronics unit of the exoskeleton. Alternatively or additionally, the vehicle can transmit a music playlist, messages, or the like for entertainment purposes to the exoskeleton. Alternatively or additionally, the vehicle can collect items of information about the seat position of the person and the behavior of the person on the seat, to be able to offer a certain seating assistance using the exoskeleton. Alternatively or additionally, the vehicle, on the basis of a detected health state of the person, a stress state of the person, a physical state of the person, or the like, can transmit items of information about the last section of the journey to the exoskeleton, to offer a certain assistance by the exoskeleton on the last section of the journey.

Furthermore, for example, monitoring of operating modes can be provided. For example, the walking mode for the last section of the journey can be monitored. Alternatively or additionally, the travel mode can be monitored. Alternatively or additionally, the secure fixing of the exoskeleton in the vehicle as the vehicle seat can be monitored. Alternatively or additionally, by monitoring the energy level of the electrical store of the exoskeleton, the energy level of the exoskeleton can be prevented from falling below a minimum energy level on the last section of the journey.

The electronic unit of the exoskeleton can be configured to monitor movements and embedded properties, for example navigation, heating, human-machine interface, smartphone interaction, and the like, of the exoskeleton.

The disclosure comprises operating modes to ensure a multimodal integration of the driven exoskeleton into the vehicle. In particular, a functional integration can occur between the exoskeleton and the vehicle.

The mechanical interface formed by the coupling station between the driven exoskeleton and the vehicle fixes the exoskeleton securely on the vehicle. The coupling station can be standardized for a variety of different vehicle types. The coupling station can enable the exoskeleton to be coupled on in a standing position. Alternatively or additionally, the coupling station can enable the exoskeleton to be coupled on in a seated position. The coupling station can be configured to maintain a direct physical contact between exoskeleton and the person using the exoskeleton. The coupling station can be configured to enable the person using the exoskeleton to harness themselves to the exoskeleton or unharness themselves from the exoskeleton, without changing their position. The coupling station can make use of existing equipment of the vehicle, for example, a vehicle seat. The coupling station can have an energy interface, for example, to supply the exoskeleton with electrical energy, for intelligent energy management, or the like.

The electronic interface can be configured to enable an entertainment data exchange. The electronic interface can be configured to enable a bidirectional sensor data exchange between the exoskeleton and the vehicle. The electronic interface can comprise a connectivity interface, for example, for Internet, navigation, or wireless communication. The electronic interface can be configured to enable a bidirectional data exchange, for example, with respect to a railway line, a health status, or the like, between the exoskeleton and the vehicle.

A data exchange can occur between the exoskeleton and the vehicle during the coupling mode and the decoupling mode, wherein the data exchange can enable a seamless fixing or disengagement of the exoskeleton to or from the coupling station. In addition, the data exchange can provide instructions to the person using the exoskeleton, to achieve coupling and decoupling successfully and easily.

According to one advantageous embodiment, the electronic unit is configured to control and/or regulate the operating state of the exoskeleton such that the exoskeleton, which is coupled or not yet coupled to the coupling station, is transferred from an upright walking state into a seated state, wherein the exoskeleton at least partially forms a seat for the person wearing the exoskeleton in the seated state. The person can, for example, enter public transit using the exoskeleton and couple the exoskeleton to a free coupling station. After this has been performed, the electronic unit can transfer the exoskeleton coupled to the coupling station from the upright walking state into the seated state. Before the exoskeleton is disengaged again from the coupling station to leave the vehicle, it is transferred via the electronic unit back from the seated state into the walking state. For example, if a person enters a passenger automobile using the exoskeleton, the electronic unit transfers the exoskeleton, which is not yet coupled to the coupling station, from the upright walking state into the seated state, whereby the sitting down of the person is assisted. Subsequently or during this, the exoskeleton is coupled to the coupling station. To leave the vehicle, the electronic unit transfers the exoskeleton back from the seated state into the walking state, whereby a standing up movement of the person is assisted. Before or during this, the exoskeleton is decoupled from the coupling station. To be able to control and/or regulate the operating state of the exoskeleton accordingly, the electronic unit is electrically connected to actuators, i.e., electrical final control elements, of the exoskeleton.

According to a further advantageous embodiment, the exoskeleton comprises at least one electrical energy source and at least one first electrical terminal, which is connected to the energy source, wherein the coupling station has at least one second electrical terminal, which is connected to an energy supply system of the vehicle, and wherein when the exoskeleton is coupled to the coupling station, the two electrical terminals are connected to one another. The electrical interface is hereafter arranged between the exoskeleton and the vehicle on the coupling station. The electrical energy source of the exoskeleton is preferably rechargeable and can be designed as a lithium-ion rechargeable battery, for example.

According to a further advantageous embodiment, the exoskeleton comprises at least one first communication terminal, which is connected to the electronic unit, wherein the coupling station has at least one second communication terminal, which is connected to the electronic device, and wherein when the exoskeleton is coupled to the coupling station, and the two communication terminals are connected to one another. The electronic interface is hereafter arranged between the exoskeleton and the vehicle on the coupling station.

According to a further advantageous embodiment, the exoskeleton comprises at least one heating unit and/or at least one cooling unit, using at least one section that is in contact with the person, which can be heated or cooled, respectively. The electronic unit of the exoskeleton can activate or deactivate the heating unit, or the cooling unit as needed, or upon request by the person, to ensure a high level of comfort.

According to a further advantageous embodiment, the exoskeleton comprises at least one massage unit and/or at least one adjustable back support unit. The electronic unit of the exoskeleton can activate or deactivate the massage unit and/or the back support unit as needed or upon request by the person, to ensure a high level of comfort.

According to a further advantageous embodiment, the exoskeleton comprises at least one adjustment unit for adjusting a seat position. This is advantageous in particular if the exoskeleton partially or completely forms a vehicle seat, because the exoskeleton enables a seat adjustment corresponding to the conventional vehicle seats. The electronic unit of the exoskeleton can activate or deactivate the adjustment unit as needed or upon request by the person, to be able to adjust an optimum seat position.

According to a further advantageous embodiment, the exoskeleton comprises at least one weather protection unit, which is transferable from an idle position into an active position, and vice versa, wherein the weather protection unit shields the person at least from above in the active position and does not shield the person in the idle position. The weather protection unit can be formed like an umbrella. The weather protection unit can be designed so it can be spread out, to be spread out in its active position and collapsed in its idle position. The electronic unit of the exoskeleton can be configured so that the weather protection unit is transferred in certain weather conditions, which are detected via a sensor system of the exoskeleton, automatically or upon request by the person from its idle position into its active position, and vice versa. The transfer of the weather protection unit from its idle position into its active position, and vice versa, can be performed via at least one actuator of the exoskeleton, which is activatable using the electronic unit. The weather protection unit can be designed as at least partially transparent. The weather protection unit can be designed such that in its active position, it at least also additionally shields a head region of the person from the front.

According to a further advantageous embodiment, at least one heads-up display and/or at least one human-machine interface is arranged on the weather protection unit. Items of information can be displayed to the person using the exoskeleton via the heads-up display, for example a route or the like. The person can adjust the items of information displayed on the heads-up display or activate or deactivate individual functions of the exoskeleton via the human-machine interface. Alternatively, the heads-up display and/or the human-machine interface can be arranged separately from the weather protection unit in the passenger compartment of the vehicle.

The exoskeleton can have various operating elements for different functions, which are operable by the person using the exoskeleton to activate or deactivate the respective function. The operating elements can be formed by physically provided switches, buttons, or the like or, for example, by a touchscreen.

As results from the above statements, the disclosure also comprises a method for operating a mobility system according to the disclosure, according to which the mobility system passes through various operating modes. According to embodiments of this method, various communications are possible between the vehicle and the exoskeleton. An exchange of electrical energy between the vehicle and the exoskeleton is also possible.

The disclosure will be explained by way of example hereafter with reference to the appended figures on the basis of preferred embodiments, wherein the features described hereafter can represent a refining or advantageous aspect of the disclosure both each taken per se or also in various combinations with one another. In the figures:

### BRIEF DESCRIPTION OF THE DRAWINGS

FIG. 1 shows a schematic and perspective illustration of an exoskeleton of an exemplary embodiment of a mobility system according to the disclosure in a coupled seated state;

FIG. 2 shows a schematic side view of an exoskeleton of a further exemplary embodiment of a mobility system according to the disclosure in a coupled seated state;

FIG. 3 shows a schematic side view of an exoskeleton of a further exemplary embodiment of a mobility system according to the disclosure in a decoupled walking state;

FIG. 4 shows a schematic illustration of a further exemplary embodiment of a mobility system according to the disclosure; and

FIG. 5 shows a flow chart of an operation of an exemplary embodiment of a mobility system according to the disclosure.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

Various exemplary embodiments of the disclosure are described hereafter on the basis of the appended figures. For the sake of simplicity, and exoskeleton without arm parts is shown in the figures, however, the disclosure is not restricted thereto. Instead, the exoskeleton can also have arm parts.

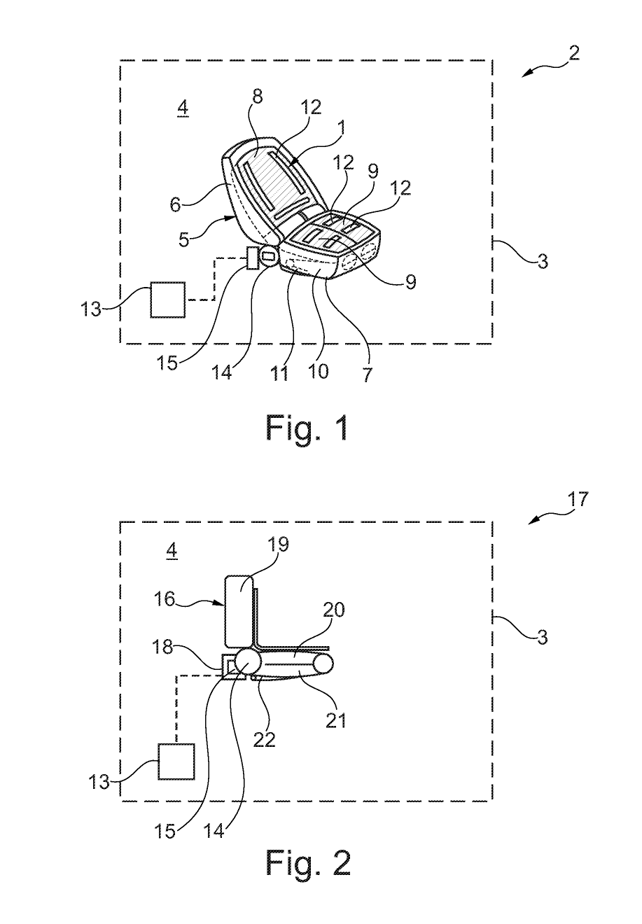

FIG. 1 shows a schematic and perspective illustration of a driven exoskeleton 1 of an exemplary embodiment of a mobility system 2 according to the disclosure in a coupled seated state. The driven exoskeleton 1 comprises at least one electronic unit (not shown) that controls and/or regulates an operating state of the exoskeleton 1. For this purpose, the electronic unit is connected to actuators (not shown) of the exoskeleton. The mobility system 2 additionally comprises a schematically indicated vehicle 3 having a passenger compartment 4 and a mechanical coupling station 5, which is arranged in the passenger compartment 4, and to which the exoskeleton 1 is mechanically coupled.

The coupling station 5 comprises a back shell 6 and a seat shell 7, wherein each shell forms a receptacle. The exoskeleton 1 comprises a back part 8, which is inserted into the receptacle formed on the back shell 6 and forms a vehicle seat surface, on which the person (not shown) can lean. Furthermore, the exoskeleton 1 comprises, for each leg of the person, a thigh part 9 articulated with the back part 8, a lower leg part 10, which is folded downward in FIG. 1 and is articulated with the thigh part 9, and a foot part 11, which is folded forward in FIG. 1 and is articulated with the lower leg part 10. The thigh parts 9, the lower leg parts 10, and the foot parts 11 are inserted into the receptacle formed on the seat shell 7. The thigh parts 9 form a vehicle seat surface, on which the person (not shown) can sit. Fixing belts 12 are arranged on the back part 8 and on the thigh parts 9, which can be extended from the back part 8 or the thigh parts 9, respectively, to buckle in or harness the person on the exoskeleton 1.

The electronic unit (not shown) of the exoskeleton 1 is configured to control and/or regulate the operating state of the exoskeleton 1 such that the exoskeleton 1, which is not yet coupled to the coupling station 5, is transferred from an upright walking state into the seated state shown, wherein the exoskeleton 1 partially forms a seat for the person wearing the exoskeleton 1 in the seated state. Subsequently, the exoskeleton 1 is fixed on the coupling station 5.

The vehicle 3 comprises an electronic device 13. The electronic unit of the exoskeleton 1 is connectable via at least one communication connection to the electronic device 13. For this purpose, the exoskeleton 1 comprises a first communication terminal 14, which is connected to the electronic unit, and the coupling station 5 comprises a second communication terminal 15, which is connected to the electronic device 13. When the exoskeleton 1 is coupled to the coupling station 5, as shown in FIG. 1, the two communication terminals 14 and 15 are connected to one another.

The exoskeleton 1 can have at least one electrical energy source (not shown) and at least one first electrical terminal (not shown), which is connected to the energy source. The coupling station 5 can have at least one second electrical terminal (not shown), which is connected to an energy supply system (not shown) of the vehicle 3. When the exoskeleton 1 is coupled to the coupling station 5, the two electrical terminals are connected to one another. The two electrical terminals can be arranged on the communication terminals 14 and 15.

The exoskeleton 1 can have at least one heating unit (not shown) and/or at least one cooling unit (not shown), using which at least one section of the exoskeleton 1 that is in contact with the person can be heated or cooled, respectively. Furthermore, the exoskeleton 1 can have at least one massage unit (not shown) and/or at least one adjustable back support unit (not shown). In addition, the exoskeleton 1 can have at least one adjustment unit (not shown) that adjusts a seat position.

The exoskeleton 1 can additionally have at least one weather protection unit (not shown), which is transferable from an idle position into an active position, and vice versa, wherein the weather protection unit shields the person at least from above in the active position and does not shield the person in the idle position. Furthermore, at least one heads-up display and/or at least one human-machine interface of the exoskeleton 1 can be arranged on the weather protection unit or separately therefrom.

FIG. 2 shows a schematic side view of an exoskeleton 16 of a further exemplary embodiment of a mobility system 17 according to the disclosure in a coupled seated state. The driven exoskeleton 16 for a person (not shown) comprises at least one electronic unit (not shown) that controls and/or regulates an operating state of the exoskeleton 16. For this purpose, the electronic unit is electrically connected to actuators (not shown) of the exoskeleton 16. The mobility system 17 additionally comprises a schematically indicated vehicle 3 having a passenger compartment 4, and a mechanical coupling station 18, which is arranged in the passenger compartment 4 and to which the exoskeleton 16 is mechanically coupled.

The exoskeleton 1 comprises a back part 19, which forms a vehicle seat surface, on which the person can lean. Furthermore, the exoskeleton 1 comprises, for each leg of the person, a thigh part 20, which is articulated with the back part 19, a lower leg part 21, which is folded downward in FIG. 1 and is articulated with the thigh part 20, and a foot part 22, which is folded forward in FIG. 1 and is articulated with the lower leg part 21. The thigh parts 20 form a vehicle seat surface, on which the person (not shown) can sit down. Fixing belts (not shown) are arranged on the back part 19 and on the thigh parts 20, which can be extended from the back part 19 or the thigh parts 20, respectively, to buckle in or harness the person on the exoskeleton 16.

The electronic unit (not shown) of the exoskeleton 16 is configured to control and/or regulate the operating state of the exoskeleton 16 such that the exoskeleton 16, which is coupled to the coupling station 18, is transferred from an upright walking state into the seated state shown, wherein the exoskeleton 16 completely forms a seat for the person wearing the exoskeleton 16 in the seated state.

The exoskeleton 16 is fixed to the coupling station 18. The vehicle 3 comprises an electronic device 13. The electronic unit (not shown) of the exoskeleton 16 is connectable via at least one communication connection to the electronic device 13. For this purpose, the exoskeleton 16 comprises a first communication terminal 14, which is connected to the electronic unit, and the coupling station 18 comprises a second communication terminal 15, which is connected to the electronic device 13, wherein when the exoskeleton 16 is coupled to the coupling station 18, as shown in FIG. 2, the two communication terminals 14 and 15 are connected to one another.

The exoskeleton 1 can have at least one electrical energy source (not shown) and at least one first electrical terminal (not shown), which is connected to the energy source. The coupling station 18 can have at least one second electrical terminal (not shown), which is connected to an energy supply system (not shown) of the vehicle 3. When the exoskeleton 16 is coupled to the coupling station 18, the two electrical terminals are connected to one another. The two electrical terminals can be arranged at the communication terminals 14 and 15.

The exoskeleton 16 can have at least one heating unit (not shown) and/or at least one cooling unit (not shown), using at least one section of the exoskeleton 16, which is in contact with the person, which can be heated or cooled, respectively. Furthermore, the exoskeleton 16 can have at least one massage unit (not shown) and/or at least one adjustable back support unit (not shown). Moreover, the exoskeleton 16 can have at least one adjustment unit (not shown) for adjusting a seat position.

The exoskeleton 16 can additionally have at least one weather protection unit (not shown), which is transferable from an idle position into an active position, and vice versa, wherein the weather protection unit shields the person at least from above in the active position and does not shield the person in the idle position. Furthermore, at least one heads-up display and/or at least one human-machine interface of the exoskeleton 16 can be arranged on the weather protection unit or separately therefrom.

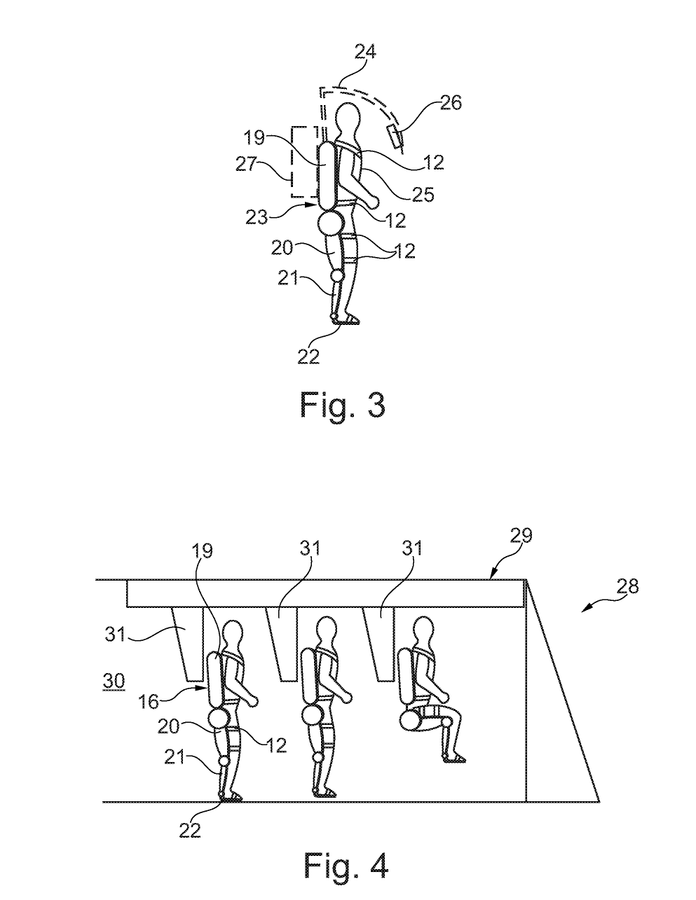

FIG. 3 shows a schematic side view of an exoskeleton 23 of a further exemplary embodiment of a mobility system according to the disclosure in a decoupled walking state, wherein only the exoskeleton 23 is shown of the mobility system. The exoskeleton 23 is designed substantially corresponding to FIG. 2, because of which reference is made to the above description of FIG. 2 to avoid repetitions. Alternatively, the exoskeleton 23 could be designed corresponding to FIG. 1.

The exoskeleton 23 thus differs, on the one hand, from the exemplary embodiment shown in FIG. 2 in that the exoskeleton 23 has a weather protection unit 24, which is transferable from an idle position into the active position shown in FIG. 3, and vice versa. The weather protection unit 24 shields the person 25 from above and partially from the front in its active position, and does not shield the person 25 in its idle position (not shown). On the other hand, the exoskeleton 23 differs from the exemplary embodiment shown in FIG. 2 in that a heads-up display 26 and/or at least one human-machine interface (not shown) is arranged on the weather protection unit 24. A carrying section 27 to carry loads is arranged on the rear of the exoskeleton 23.

FIG. 4 shows a schematic illustration of a further exemplary embodiment of a mobility system 28 according to the disclosure. The mobility system 28 comprises at least three driven exoskeletons 16 for people 25, wherein the exoskeletons 16 each have an electronic unit (not shown) that controls and/or regulates an operating state of the respective exoskeleton 16. In addition, the mobility system 28 comprises at least one vehicle 29 in the form of public transit having a passenger compartment 30 and at least three mechanical coupling stations 31, which are arranged in the passenger compartment 30 and, to each, an exoskeleton 16 can be mechanically coupled. The exoskeleton 16 is designed corresponding to the exemplary embodiment shown in FIG. 2, because of which reference is made to the above description of FIG. 2 to avoid repetitions.

The electronic unit (not shown) of each exoskeleton 16 is configured to control and/or regulate the operating state of the exoskeleton 16 such that the exoskeleton 16 coupled to the respective coupling station 31 is transferred from an upright walking state into a seated state, wherein the exoskeleton 16 at least partially forms a seat for the person wearing the exoskeleton 16 in the seated state. Such a seated state is visible in the case of the exoskeleton 16 shown on the right in FIG. 4. The two remaining exoskeletons 16 are coupled in the upright walking state thereof to the respective coupling station 31.

Each exoskeleton 16 can have at least one electrical energy source (not shown) and at least one first electrical terminal (not shown), which is connected to the energy source. Each coupling station 31 can have at least one second electrical terminal (not shown), which is connected to an energy supply system (not shown) of the vehicle 29, wherein when the exoskeleton 16 is coupled to the respective coupling station 31, the two electrical terminals are connected to one another, as described above.

The vehicle 29 can have at least one electronic device (not shown), to which the electronic unit of the exoskeleton 16 is connectable via at least one communication connection. For this purpose, each exoskeleton 16 can have at least one first communication terminal (not shown), which is connected to the electronic unit, and each coupling station 31 can have at least one second communication terminal (not shown), which is connected to the electronic device, wherein when the exoskeleton 16 is coupled to the respective coupling station 31, the two communication terminals are connected to one another.

Moreover, each exoskeleton 16 can have at least one heating unit and/or at least one cooling unit, using which at least one section of the exoskeleton 16 that is in contact with the person 25 can be heated or cooled, respectively. Furthermore, each exoskeleton 16 can have at least one massage unit (not shown) and/or at least one adjustable back support unit (not shown). Moreover, each exoskeleton 16 can have at least one adjustment unit (not shown) that adjusts a seat position.

The exoskeleton 16 can have at least one weather protection unit (not shown), which is transferable from an idle position into an active position, and vice versa, wherein the weather protection unit shields the person 25 at least from above in the active position, and does not shield the person 25 in the idle position. The weather protection unit can be designed corresponding to FIG. 3. At least one heads-up display (not shown) and/or at least one human-machine interface (not shown) can be arranged on the weather protection unit.

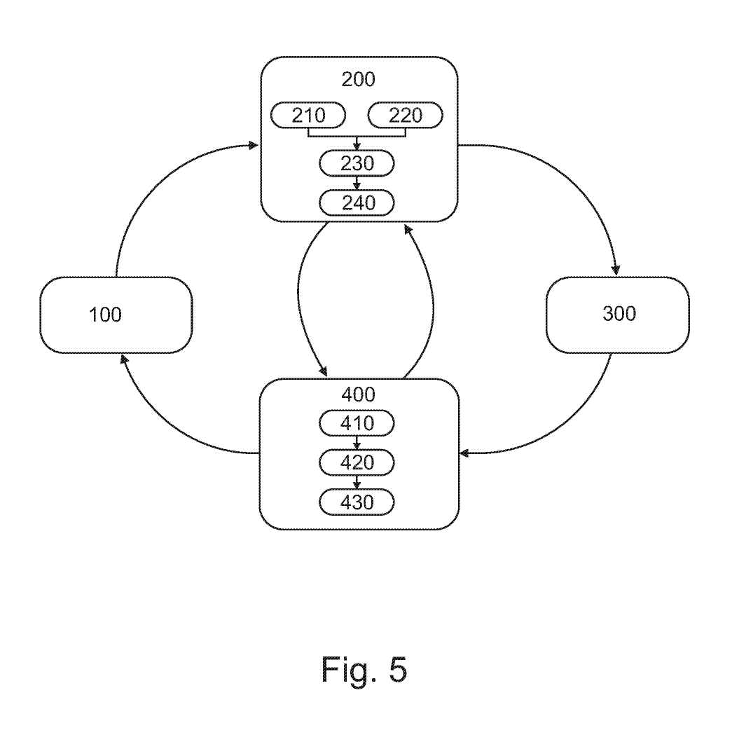

FIG. 5 shows a flow chart of an operation of an exemplary embodiment of a mobility system according to the disclosure. Firstly, a user of the mobility system, while using an exoskeleton in a walking mode 100, can walk to a vehicle, wherein at least a section of a journey is to be carried out. Next, the user of the exoskeleton, for example, by actuating an operating element, can indicate that he wishes to enter the vehicle. If the vehicle is at a standstill, the vehicle can indicate whether it is in a state to couple the exoskeleton to a free coupling station in its passenger compartment.

After entering the vehicle, the exoskeleton can be transferred from the walking mode 100 into a coupling mode 200 automatically, or by a manual activation by the user. The coupling mode 200 comprises a sitting-down sub-mode 210, a standing-up sub-mode 220, a fixing sub-mode 230, and an unharnessing sub-mode 240, which are described above.

If the coupling of the exoskeleton to the coupling station in the passenger compartment of the vehicle is completed, the exoskeleton can automatically change into a travel mode 300, in which electrical energy and/or data can be exchanged between the exoskeleton and the vehicle.

The user of the exoskeleton can, for example, by actuating an operating element, indicate his intention of wanting to disembark from the vehicle. If the vehicle is at a standstill and the vehicle indicates that decoupling from the coupling station can be carried out safely, the exoskeleton can be transferred from the travel mode 300 into a decoupling mode 400 automatically, or via a user-side manual actuation of an operating element. The decoupling mode 400 comprises a harnessing sub-mode 410, a disengagement sub-mode 420, and a disembarking sub-mode 430. The harnessing sub-mode 410 and the disengagement sub-mode 420 are described above. The disembarking sub-mode 430 is assumed by the exoskeleton when the exoskeleton is disengaged from the coupling station. The exoskeleton can be transferred directly from the coupling mode 200 into the decoupling mode 400, and vice versa, if the user of the exoskeleton indicates by a manual actuation of an operating element that he has changed his intention.

After completion of the decoupling mode 400, the user leaves the vehicle together with the exoskeleton and the exoskeleton is transferred back into the walking mode 100 automatically or manually by the user.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A vehicle mobility system comprising:
at least one driven exoskeleton having at least one electronic unit configured to control and regulate an operating state of the exoskeleton;
a passenger compartment having at least one coupling station disposed in the passenger compartment configured to mechanically couple the exoskeleton to the at least one coupling station; and
at least one electronic device connectable via at least one communication connection to the at least one electronic unit.

2. The vehicle mobility system as claimed in claim 1, wherein the electronic unit for the at least one driven exoskeleton is configured to control and regulate the operating state such that the exoskeleton, being coupled or uncoupled to the coupling station, is transferred from an upright walking state into a seated state that at least partially forms a seat.

3. The vehicle mobility system as claimed in claim 1, wherein the at least one driven exoskeleton includes at least one electrical energy source and a first electrical terminal that is connected to the energy source.

4. The vehicle mobility system as claimed in claim 3, wherein the at least one coupling station includes a second electrical terminal that is connected to a vehicle energy supply system such that the at least one driven exoskeleton is coupled to the coupling station when the first electrical terminal is connected to the second electrical terminal.

5. The vehicle mobility system as claimed in claim 1, wherein the at least one driven exoskeleton includes a first communication terminal that is connected to the electronic unit.

6. The vehicle mobility system as claimed in claim 4, wherein the coupling station includes a second communication terminal that is connected to the electronic device such that the exoskeleton is coupled to the coupling station when the first communication terminal is connected to the second communication terminal.

7. The vehicle mobility system as claimed in claim 1, wherein the exoskeleton includes at least one weather protection unit that is transferable from an idle position into an active position such that the weather protection unit shields a person from above in the active position.

8. The vehicle mobility system as claimed in claim 7, wherein at least one heads-up display is arranged on the weather protection unit.

9. A vehicle comprising:
a coupling station, disposed in a passenger compartment, that mechanically couples an exoskeleton to the passenger compartment;
a control unit configured to change an exoskeleton operating state that moves the exoskeleton between seated and upright states, defined by the exoskeleton being coupled and uncoupled to the coupling station, respectively; and
an electronic device connectable, via a vehicle communication connection, to the control unit to communicate the operating state to the electronic device.

10. The vehicle as claimed in claim 9 further comprising energy source connected to a first electrical terminal of the exoskeleton.

11. The vehicle as claimed in claim 10 further comprising a vehicle energy supply system connected to a second electrical terminal of the coupling station such hat the exoskeleton is coupled to the coupling station when the first electrical terminal is connected to the second electrical terminal.

12. The vehicle as claimed in claim 9 further comprising a first communication terminal defined on the exoskeleton that is connected to the control unit.

13. The vehicle as claimed in claim 12 further comprising a second communication terminal that is connected to the electronic device such that the exoskeleton is coupled to the coupling station when the first communication terminal is connected to the second communication terminal.

14. The vehicle as claimed in claim 9 further comprising a protection unit attached to the exoskeleton that is transferable from an idle position into an active position.

15. A mobility system comprising:
a vehicle having a passenger compartment with an exoskeleton coupling station, and an electronic device configured to control an interface; and
an exoskeleton including an electronic control unit to control an exoskeleton operating state that moves the exoskeleton between an upright walking state defined by the exoskeleton being uncoupled to the coupling station, and a seated state defined by the exoskeleton being coupled to the coupling station, wherein the electronic control unit is further configured to communicate the exoskeleton operating state to the electronic device via a vehicle communication network to display the operating state on the interface.

16. The mobility system as claimed in 15, wherein the exoskeleton includes an energy source connected to a first electrical terminal.

17. The mobility system as claimed in 16, wherein the coupling station includes a second electrical terminal that is connected to an energy supply for the vehicle such that the exoskeleton is coupled to the coupling station when the first electrical terminal is connected to the second electrical terminal.

18. The mobility system as claimed in 15, wherein the exoskeleton includes a first communication terminal that is connected to the electronic control unit.

19. The mobility system as claimed in 18, wherein the coupling station includes a second communication terminal that is connected to the electronic device such that the exoskeleton is coupled to the coupling station when the first communication terminal is connected to the second communication terminal.

20. The mobility system as claimed in 15, wherein the exoskeleton includes a protection unit that is transferable from an idle position into an active position.
